(19) United States
(12) Patent Application Publication
(10) Pub. No.: US 2016/0102801 A1
(43) Pub. Date: Apr. 14, 2016

(54) ROTARY DEVICE FOR IMAGE-CAPTURING EQUIPMENT

(71) Applicant: LEADINWAY CO., LTD., Jubi City (TW)

(72) Inventor: Raymond CHU, Jubi City (TW)

(73) Assignee: LEADINWAY CO., LTD.

(21) Appl. No.: 14/509,233

(22) Filed: Oct. 8, 2014

(51) Int. Cl. F16M 11/08

(52) U.S. Cl. CPC F16M 11/08

(57) ABSTRACT

A rotary device for image-capturing equipment comprises a support structure and a rotating structure. The support structure comprises a pillar, a support frame and a transmission component. The pillar comprises a bottom end and a top end opposite to the bottom end; the support frame comprises an engaging end and a bearing end opposite to the engaging end, wherein the engaging end is connected to the top end of the pillar; and the rotating structure comprises a bearing and a strut connected to the bearing. The bearing is rotatably mounted at the bearing end of the support frame of the support structure for rotating the rotating structure. Image-capturing equipment mounted at a fixed end of the strut of the rotating structure can rotatably shoot images in 360 degrees around the subject from multi-faceted perspectives.

### BACKGROUND OF THE INVENTION

1. Field of the Invention

The present invention relates to a rotary device, particularly to a rotary device having a support structure and a rotating structure for shooting images rotatably.

2. Description of the Prior Arts

When a guest is to have a hair cut at a beauty salon, the guest can only discuss with the hair designer which kind of hair style the guest likes according to the photos of the models on the magazine. However, a commonly encountered trouble is that even the hair cut is done according to the magazine, the hair style is not suitable for this particular individual, and the guest leaves the salon disappointed.

With the progression and popularity of the image-capturing equipment and the digital image-processing technology, almost every industry is using the image-capturing equipment and the digital image-processing technology, and even the smart phones used by every end-consumer has combined the image-capturing equipment and the digital image-processing technology. The beauty salon also incorporates image-capturing equipment so that the guest can, before starting the hair cutting, preview the model's hair style applied on the guest's own head and face, through the digital image-processing technology. The guest can realize whether the model's hair style matches himself or herself.

Conventional image-capturing equipment is stationary, so the guest is asked to rotate in person for taking head shots. However, the self-rotating not only deviates from the rotation center, causing difficulty of the post-production of images, but also makes the guest feel inconvenient. Therefore, the disadvantages in prior art should be solved.

### SUMMARY OF THE INVENTION

According to the above description, the present invention provides a rotary device for image-capturing equipment having a support structure and a rotating structure, so that the image-capturing equipment is capable of shooting in 360 degrees rotation.

The objective of the invention is to provide a rotary device for image-capturing equipment comprising a support structure and a rotating structure. The support structure comprises a pillar, a support frame and a transmission component; wherein the pillar comprises a bottom end and a top end opposite to the bottom end; the support frame comprises an engaging end and a bearing end opposite to the engaging end, wherein the engaging end is connected to the top end of the pillar; and the transmission component is located in the support frame comprising a motor and a transmission belt, wherein the motor is mounted in the engaging end of the support frame, and the transmission belt is connected to the motor. The rotating structure comprises a bearing and a strut; wherein the bearing is mounted rotatably at the bearing end of the support frame of the support structure for rotating the rotating structure; the bearing is mounted at an end of the transmission belt that is opposite the top end of the pillar; and the strut comprises an axis end and a fixed end opposite to the axis end, wherein the axis end is mounted at the bearing.

Preferably, the support frame further comprises a bracket located at the bearing end of the support frame, and the bearing of the rotating structure is inserted into the bracket and connected with the bracket.

Preferably, the rotating structure further comprises multiple rods each comprising a connected end and an end portion opposite to the connected end, wherein the connected end is mounted at the bearing.

More preferably, the rotating structure comprises three rods.

Preferably, the transmission belt is a belt or a chain.

Preferably, the motor is a stepper motor, a direct current motor or an alternating current motor.

Preferably, the support structure further comprises a hinge, wherein the hinge is rotatably mounted between the top end of the pillar and the engaging end of the support frame for pivoting both of the pillar and the support frame.

Preferably, the support structure further comprises a power controller connected to the bottom end of the pillar.

Preferably, the support structure further comprises a base mounted at the bottom end of the pillar.

Preferably, the pillar further comprises a first post and a second post connected to the first post, wherein the first post is adjacent to the top end of the pillar, wherein the second post is adjacent to the bottom end of the pillar, and a cross-sectional perimeter of the second post is smaller than a cross-sectional perimeter of the first post.

Preferably, the support frame further comprises two first frames and a second frame connected to the first frames, wherein the first frames are respectively located at the engaging end and the bearing end of the support frame, the second frame is located between the two first frames, and a cross-sectional perimeter of the second frame is smaller than a cross-sectional perimeter of each of the first frames.

The advantages of the present invention are:

1. The rotary device for image-capturing equipment of the present invention can rotate 360 degrees around the subject for shooting images from multi-faceted perspectives.

2. The rotary device for image-capturing equipment of the present invention is rotated around a center such that the subject can stay at the center and pose for the shooting, and the post-production of images is much easier.

3. The motor of the rotary device for image-capturing equipment of the present invention is mounted at the pillar for balancing the rotary device for image-capturing equipment.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a rotary device for image-capturing equipment of the present invention;

FIG. 2 is a partially cross-sectional view of the rotary device for image-capturing equipment;

FIG. 3 is a partially perspective view of the rotary device for image-capturing equipment;

FIG. 4 is a partially exploded view of the rotary device for image-capturing equipment;

FIG. 5 is a partially perspective view of the rotary device for image-capturing equipment; and

FIG. 6 illustrates an operational view of the rotary device for image-capturing equipment.

### DETAILED DESCRIPTION OF THE PREFERRED EMBODIMENTS

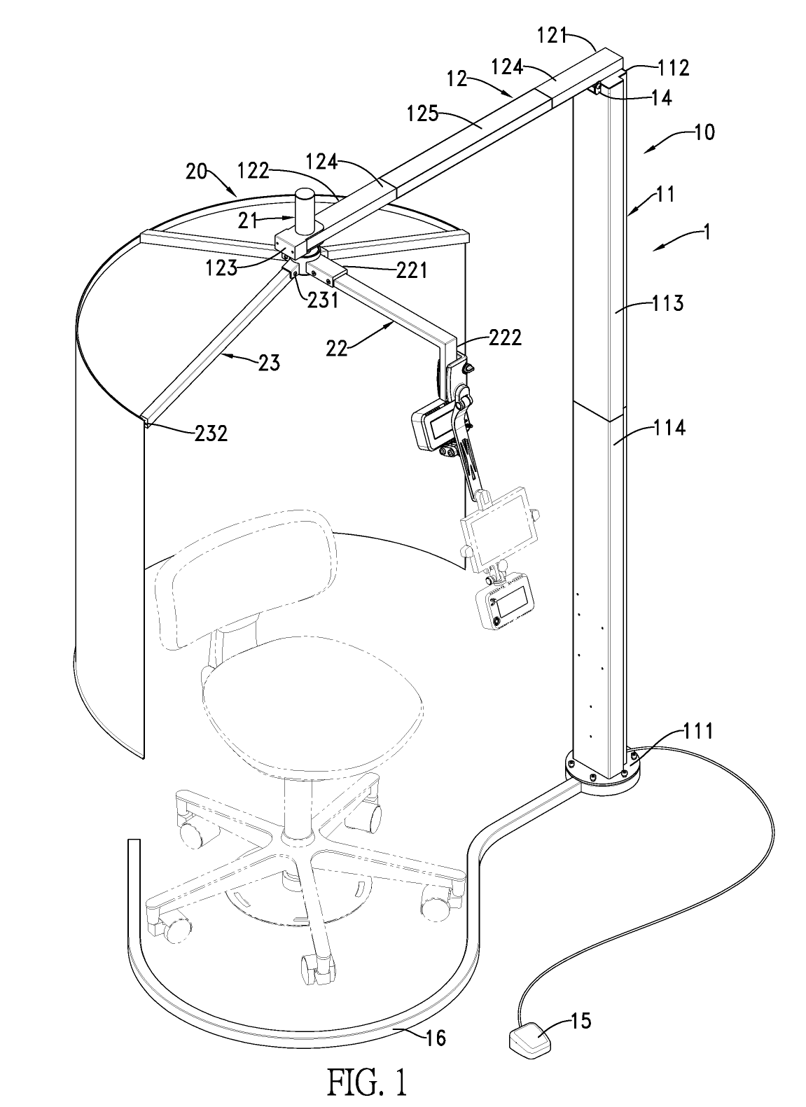

As shown in FIG. 1, the present invention provides a rotary device 1 for image-capturing equipment, the rotary device 1 comprising a support structure 10 and a rotating structure 20.

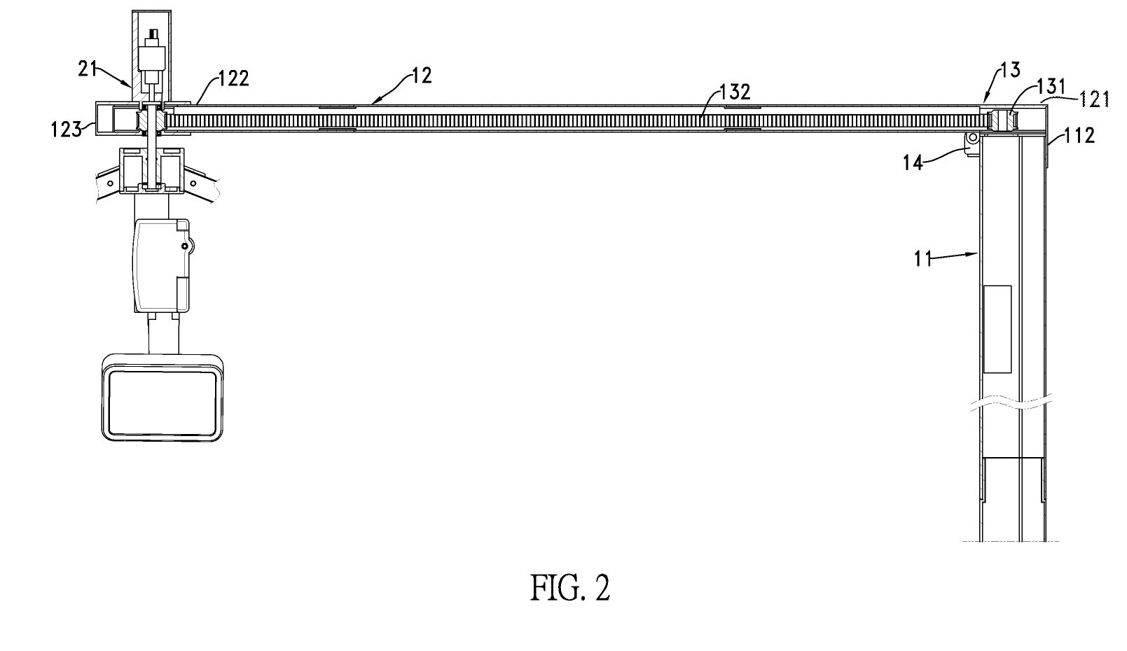

As shown in FIGS. 1 and 2, the support structure 10 comprises a pillar 11, a support frame 12 and a transmission component 13. The pillar 11 comprises a bottom end 111 and a top end 112 opposite to the bottom end 111. In another preferred embodiment, the pillar 11 further comprises a first post 113 and a second post 114 connected to the first post 113, wherein the first post 113 is adjacent to the top end 112 of the pillar 11, and the second post 114 is adjacent to the bottom end 111 of the pillar 11. A cross-sectional perimeter of the second post 114 is smaller than a cross-sectional perimeter of the first post 113 to facilitate ease of separating the first post 113 and the second post 114. In another preferred embodiment, the pillar 11 has a wireless receiver and a power supply. The support frame 12 comprises an engaging end 121 and a bearing end 122 opposite to the engaging end 121, wherein the engaging end 121 is connected to the top end 112 of the pillar 11. The support frame 12 further comprises a bracket 123 located at the bearing end 122 of the support frame 12.

In another preferred embodiment, the support frame 12 further comprises two first frames 124 and a second frame 125 connected to the first frames 124, the first frames 124 are respectively located at the engaging end 121 and the bearing end 122 of the support frame 12, wherein the second frame 125 is located between the two first frames 124, and a cross-sectional perimeter of the second frame 125 is smaller than a cross-sectional perimeter of each of the first frames 124 for separating the two first frame 124 and the second frame 125.

As shown in FIG. 2, in a preferred embodiment, the transmission component 13 is located in the support frame 12 and comprises a motor 131 and a transmission belt 132, wherein the motor 131 is mounted in the engaging end 121 of the support frame 12, and the transmission belt 132 is connected to the motor 131. In a preferred embodiment, the motor 131 is a stepper motor, a direct current motor, or an alternating current motor. The transmission belt 132 is a belt or a chain.

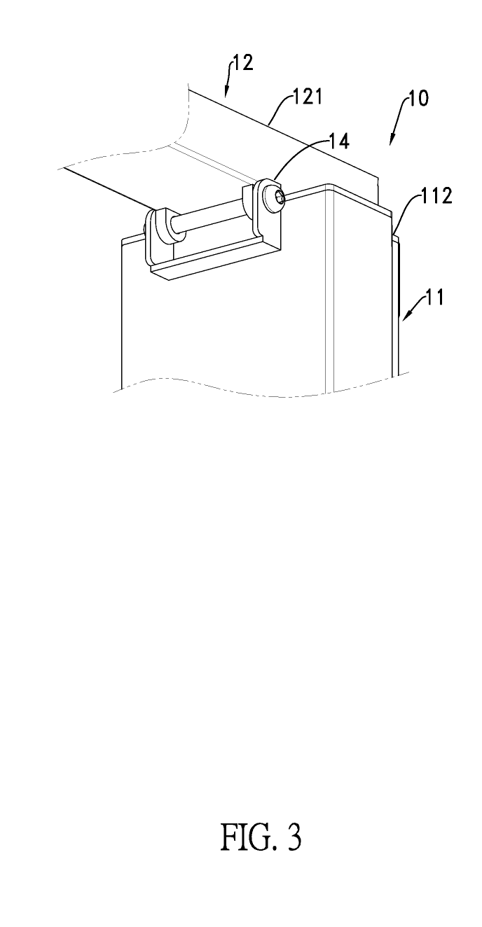

As shown in FIG. 3, in another preferred embodiment, the support structure 10 further comprises a hinge 14, and the hinge 14 is rotatably mounted between the top end 112 of the pillar 11 and the engaging end 121 of the support frame 12 for pivoting both of the pillar 11 and the support frame 12. As shown in FIG. 1, in another preferred embodiment, the support structure 10 further comprises a power controller 15 connected to the bottom end 111 of the pillar 11. In another preferred embodiment, the support structure 10 further comprises a base 16 mounted at the bottom end 111 of the pillar 11, wherein the base 16 is a rod body, and the shape of the base 16 includes, but is not limited to, the curved shape or the C-shape.

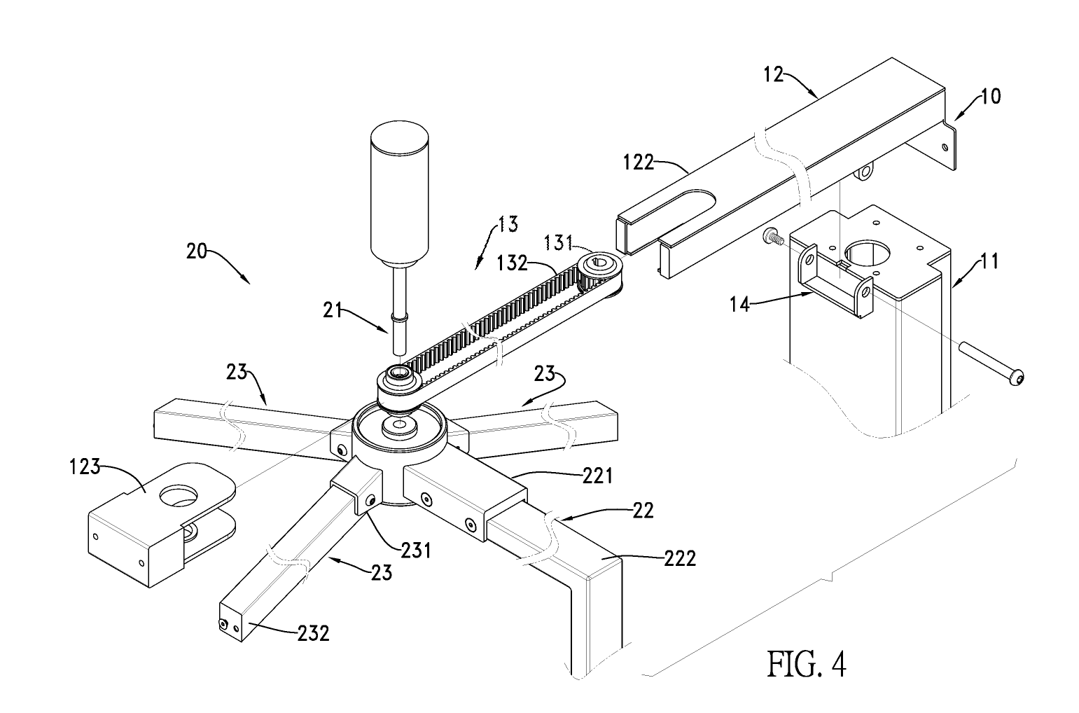

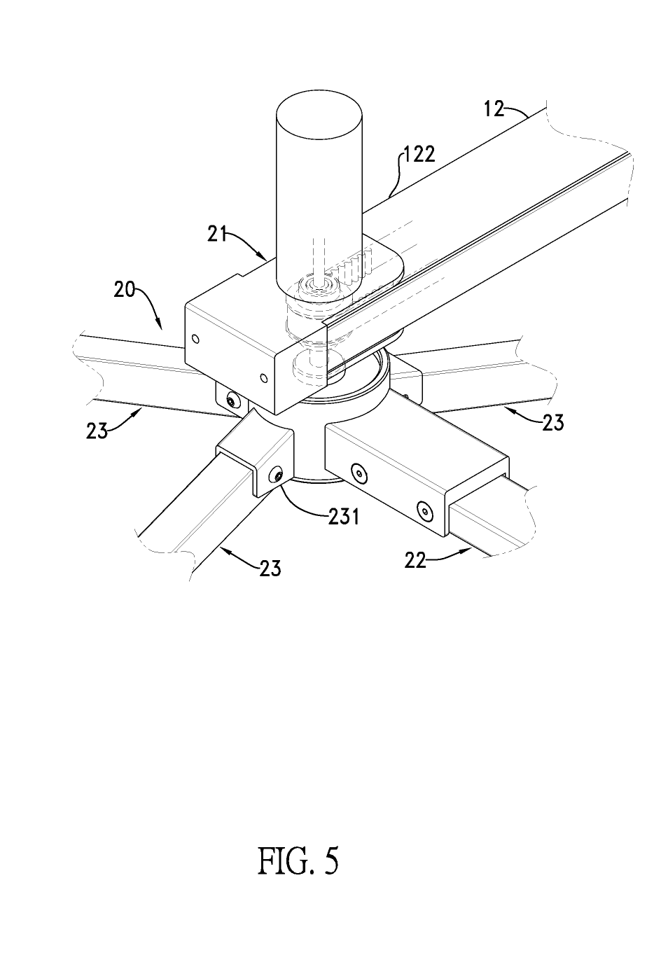

As shown in FIGS. 4 and 5, the rotating structure 20 comprises a bearing 21 and a strut 22 connected to the bearing 21. The bearing 21 is rotatably mounted at the bearing end 122 of the support frame 12 of the support structure 10 for rotating the rotating structure 20; the bearing 21 is inserted into the bracket 123 of the support frame 12 of the support structure 10, and the bearing 21 is connected to the transmission belt 132 of the transmission component 13 of the support structure 10, and the transmission belt 132 is rotated around the bearing 21 driven by the motor 131 of the transmission component 13. The strut 22 comprises an axis end 221 and a fixed end 222 opposite to the axis end 221, wherein the axis end 221 is mounted at the bearing 21, and the fixed end 222 is connected to an image-capturing equipment. In another preferred embodiment, the rotating structure 20 further comprises multiple rods 23 each comprising a connected end 231 and an end portion 232 opposite to the connected end 231, wherein the connected end 231 is mounted at the bearing 21. The end portions 232 of each of the rods 23 are connected to a background screen for image shooting. In another preferred embodiment, the rotating structure 20 comprises three rods 23, wherein each two adjacent rods 23 are at an angle of 90 degrees relative to each other, and each two opposite rods 23 are at an angle of 180 degrees relative to each other.

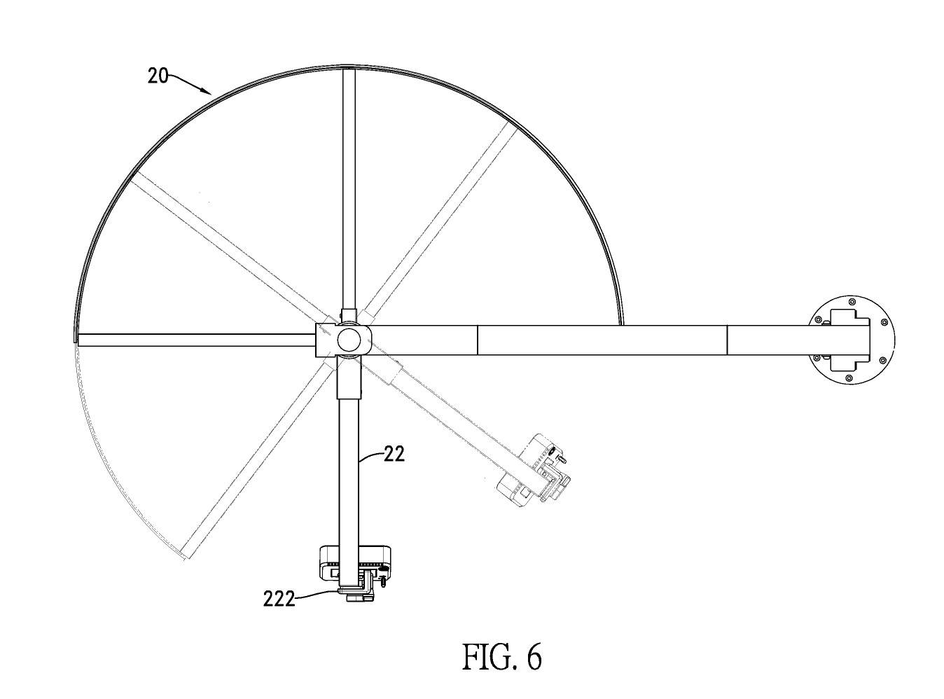

As shown in FIGS. 1 and 6, when the present invention is in use, the fixed end 222 of the strut 22 of the rotating structure 20 can be connected to the image-capturing equipment, such as a camera, a video recorder or a cell phone having photographing function, for image shooting. Moreover, a screen under the image-capturing equipment can display the simulated hairstyle. The rotary device 1 for image-capturing equipment of the present invention can be triggered by the application installed in the computer or the smart phone wirelessly (such as via Bluetooth or Wi-Fi), to remote control the wireless receiver in the pillar 11 for actuating the motor 131 mounted at the top end 112 of the pillar 11; or the motor 131 mounted at the top end 112 of the pillar 11 can be manually actuated by the power controller 15 connected to the bottom end 111 of the pillar 11.

The transmission belt 132 is moved when the motor 131 is actuated, the bearing 21 of the rotating structure 20 is rotated by the transmission belt 132, and the rotating structure 20 can be rotated through the above transmissive connection. The image-capturing equipment mounted at the fixed end 222 of the strut 22 of the rotating structure 20 can rotatably shoot images in 360 degrees.

To store the rotary device 1 for image-capturing equipment of the present invention, the support frame 12 can pivot to the pillar 11 via the hinge 14 located at the engaging end 121 of the support frame 12, and the pillar 11 can align and combine with the support frame 12 in parallel. The first post 113 and the second post 114 of the pillar 10 can be separated, and the first frames 124 and the second frame 125 of the support frame 12 can be separated to minimize the volume of the rotary device 1 for storage.

In another preferred embodiment, an oblique rod is located between the pillar 11 and support frame 12 for supporting the pillar 11 and the support frame 12, and a rotatable pivot is located between the pillar 11 and the support frame 12. When storing the rotary device 1 for image-capturing equipment of the present invention, the oblique rod can be separated from the pillar 11 and the support frame 12 so that the support frame 12 can pivot 90 degrees and abut the pillar 11.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A rotary device for image-capturing equipment, comprising:
a support structure, comprising
a pillar comprising a bottom end and a top end opposite to the bottom end;
a support frame comprising an engaging end and a bearing end opposite to the engaging end, wherein the engaging end is connected to the top end of the pillar; and
a transmission component located in the support frame and comprising a motor and a transmission belt, wherein the motor is mounted in the engaging end of the support frame, and the transmission belt is connected to the motor; and
a rotating structure, comprising
a bearing mounted rotatably at the bearing end of the support frame of the support structure for rotating the rotating structure; the bearing mounted at an end of the transmission belt that is opposite the top end of the pillar; and
a strut comprising an axis end and a fixed end opposite to the axis end, wherein the axis end is mounted at the bearing.

2. The rotary device for image-capturing equipment according to claim 1, wherein the support frame further comprises a bracket located at the bearing end of the support frame, and the bearing of the rotating structure is inserted into the bracket and connected with the bracket.

3. The rotary device for image-capturing equipment according to claim 1, wherein the rotating structure further comprises multiple rods each comprising a connected end and an end portion opposite to the connected end, wherein the connected end is mounted at the bearing.

4. The rotary device for image-capturing equipment according to claim 3, wherein the rotating structure comprises three rods.

5. The rotary device for image-capturing equipment according to claim 1, wherein the transmission belt is a belt or a chain.

6. The rotary device for image-capturing equipment according to claim 1, wherein the motor is a stepper motor, a direct current motor, or an alternating current motor.

7. The rotary device for image-capturing equipment according to claim 1, wherein the support structure further comprises a hinge, and the hinge is rotatably mounted between the top end of the pillar and the engaging end of the support frame for pivoting both of the pillar and the support frame.

8. The rotary device for image-capturing equipment according to claim 1, wherein the support structure further comprises a power controller connected to the bottom end of the pillar.

9. The rotary device for image-capturing equipment according to claim 1, wherein the support structure further comprises a base mounted at the bottom end of the pillar.

10. The rotary device for image-capturing equipment according to claim 1, wherein the pillar further comprises a first post and a second post connected to the first post, wherein the first post is adjacent to the top end of the pillar, wherein the second post is adjacent to the bottom end of the pillar, and a cross-sectional perimeter of the second post is smaller than a cross-sectional perimeter of the first post.

11. The rotary device for image-capturing equipment according to claim 1, wherein the support frame further comprises two first frames and a second frame connected to the first frames, wherein the first frames are respectively located at the engaging end and the bearing end of the support frame, the second frame is located between the two first frames, and a cross-sectional perimeter of the second frame is smaller than a cross-sectional perimeter of each of the first frames.
